(19) United States
(12) Patent Application Publication
(10) Pub. No.: US 2010/0187839 A1
(43) Pub. Date: Jul. 29, 2010

(54) HANDLE ASSEMBLY

(76) Inventor: Sean Barlett, Jyderup (DK)

Correspondence Address: HARNESS, DICKEY & PIERCE, P.L.C., P.O. BOX 8910, RESTON, VA, 20195, US

(21) Appl. No.: 12/452,642

(22) PCT Filed: Jul. 29, 2008
(86) PCT No.: PCT/EP2008/059927

§ 371 Date: Jan. 13, 2010

Related U.S. Application Data
(60) Provisional application No. 60/935,197, filed on Jul. 31, 2007.

(30) Foreign Application Priority Data
Jul. 31, 2007 (DK) PA 2007 01107

(51) Int. Cl. E05B 3/04

(52) U.S. Cl. 292/348

(57) ABSTRACT

A handle assembly for operating a locking device, the handle assembly comprising a first and a second handle lever and a rod shaped interconnection member defining a first and a second end for attachment of the first and second handle levers. The interconnection member being adapted to extend into a passage of the handle levers and at least one of the handle levers comprises a fastening means for unidirectionally locking the interconnection member inside the passage.

### FIELD OF THE INVENTION

The present invention relates to a handle assembly comprising a first and a second handle lever for operating a locking device by rotating one of the handle levers between a first and a second position. In particular the present invention relates to a handle assembly wherein the first and second handle levers may be coupled to each other without use of tools. Moreover, the present invention relates to a rosette for rotationally supporting a handle lever, which rosette is adapted to allow a handle lever to be attached to a door without use of bolts for rotationally locking the rosette relative to the door.

### BACKGROUND OF THE INVENTION

Handle assemblies for operating a locking device are known in the art. Such handle assemblies may comprise two handle levers interconnected by an interconnection member. The handle levers are attached to the interconnection member by means of screws, whereby assembly of the handle assembly is time consuming. Accordingly it is an object of a preferred embodiment of the present invention, to provide a handle assembly wherein the handle levers may be attached to the interconnection member in one step and without use of tools.

### DESCRIPTION OF THE INVENTION

In a first aspect, the present invention relates to a handle assembly for operating a locking device having a locking member adapted to be moved between a locking and a non-locking position by manipulation of a manoeuvring member of the locking device, the handle assembly comprising:
a first and a second handle lever;
a rod shaped interconnection member defining two opposite ends each of which is adapted to be received in a passage of the first and/or second handle lever, the interconnecting member being adapted to extend through the locking device such that the interconnection member engages the manoeuvring member, whereby manipulation of one of the handle levers causes the locking member to be moved between the locking and the non-locking position; and
a fastening means for fastening the interconnection member to one of the handle levers when the interconnection member is inserted into the passage of the respective handle lever, and

wherein the fastening means has a fastening position in which the fastening means unidirectionally locks the interconnection member for movement out of and away from the handle lever while allowing further movement of the interconnection member into the handle lever.

An advantage of the handle assembly according to the present invention is, that the handle levers may be attached to the interconnecting member in an infinite number of positions, whereby slack between a rosette of the handle lever and the door may be avoided. Moreover, an advantage of the present invention is, that the handle assembly may be attached to a door/locking device in one step and without use of tools, due to the provision of the fastening means allowing the interconnection member to be inserted into handle lever in one single movement. This saves time when a plurality of handle assemblies are to be installed, such as in connection with erection of large office buildings, houses, ferries etc.

The handle assembly may be adapted to operate a locking device having a locking member for engaging a door frame or the like. The locking member may define a locking position wherein the locking member extends out of the locking device and—when the locking device is installed in a door or the like—engage a door frame when the door is closed. Moreover, the locking device may be adapted to be moved to a non-locking position wherein the locking member is retracted into the locking device so as to allow the door, window etc., to be opened. In order to move the locking member between the locking and the non-locking position, the locking device may comprise a manoeuvring member which is rotatable so as to move the locking member between the locking and the non-locking position.

The locking device may be adapted to be installed in a hinged door or window or a slidably arranged door or window. Moreover it will be appreciated, that the locking device may be installed in any other means for closing an opening in a house, a room, cupboard, box etc.

The handle assembly comprises a first and a second handle lever defining a gripping portion allowing a user to rotate/slide the handle assembly so as to lock or unlock the locking device. The handle levers are attachable to an interconnection member and at least one of the handle levers are adapted to be attached to the interconnection member in an infinite number of positions.

Upon delivery of the handle assembly one or both of the handle levers may not be attached to the interconnection member. In one embodiment one of the handle levers are attached to the interconnection member by means of a screw so as to lock the interconnection member for movement in both directions inside said handle lever, i.e. into and out of the passage of the handle lever. In said embodiment, the other of the handle levers may comprise the fastening means according to the present invention, allowing said handle lever to be attached to the interconnection member in an infinite number of positions. Supply of such a handle assembly makes it easy to assemble the handle assembly, as the process of assembling only comprises the steps of:
inserting the interconnection member into the locking device such that the interconnection member extends through the locking device and is accessible on the other side of the locking device, and
pressing the other handle lever onto the interconnection member until said handle lever and the interconnection member cannot be moved any further relative to each other.

In another embodiment neither of the handle levers are attached to the interconnection member, and thus the process of assembling the handle assembly comprises the steps of:
inserting the interconnection member into the locking device such that the interconnection member extends through the locking device and is accessible on the other side of the locking device,
pressing the first handle lever onto the interconnection member, and
pressing the second handle lever onto the interconnection member until the first and the second handle levers cannot be moved further towards each other.

When the interconnection member is inserted into the locking device, it engages the manoeuvring member of the locking device whereby the locking member may be moved between the locking and the non-locking position by rotating the handle levers between corresponding two positions.

In one embodiment, the fastening means is adapted to allow the interconnection member to be fastened to the handle lever in an infinite number of positions. One advantage of such an arrangement is that slack between the handle lever and the door/window onto which the handle assembly is attached, may be avoided. This is desirable as the thickness of doors/windows varies. Accordingly, the present invention provides a handle assembly for assembling the handle levers to the interconnection member in one step—independent on the thickness of the door/window and without use of tools.

In order to allow the handle lever to be fastened to the interconnection member in an infinite number of positions, the fastening means may define en engagement surface which, when the interconnection member is received in the passage of the handle lever, engages an outer surface of the interconnection member. Moreover, the outer surface of the interconnection member may be smooth and/or non-toothed so as to allow said infinite locking of the two elements relative to each other.

In one embodiment, the fastening means defines two engagement surfaces which, when the interconnection member is received in the passage of the handle lever, engage two opposite surfaces of the interconnection member, i.e. surfaces facing away from each other.

In one embodiment, the fastening means defines an opening for receiving the interconnection member. The opening may define the two engagement surfaces. The opening may be defined in a fastening zone of the fastening means. The width of the opening may be larger than the thickness of the interconnection member whereby the fastening zone must be provided at an angel—relative to the longitudinal direction of the interconnection member—in order to ensure that the engagement surfaces engage the interconnection member.

In one embodiment, the fastening means is adapted to be moved between:
an non-fastening position in which the interconnection member is not locked for movement into and out of the passage of the handle lever, and
a fastening position wherein the interconnection member is locked for movement out of the passage of the handle lever.

When the fastening means is provided in the fastening position, the fastening zone may be provided at an angle relative to the interconnection member as described above. In order to unlock the fastening member, the fastening zone may be rotated relative to the interconnection member such that the engagement surfaces disengage the interconnection member. When the fastening means is provided in the non-fastening position the fastening zone may be closer to defining a right angel with interconnection member, than when the fastening means is provided in the fastening position.

In order to allow a user to move the fastening means between the fastening and the non-fastening position, the fastening means may comprise a fastening lever for moving the engagement surface between the fastening and the non-fastening position. The fastening lever may be operable from an outer surface of the handle lever.

In one embodiment the fastening means comprises/defines means for biasing the fastening means into the fastening position. Such biasing means may take the form of a spring, a resilient element or the like. In one embodiment, the fastening means is made from a flexible material and said material is bend so as to define a resilient zone adapted to force the fastening zone to be defined at an angel (different from 90 degrees) to the interconnection member.

In order to allow the fastening lever to be operable from an outer surface of the handle lever, the handle lever may define an aperture extending between the passage and an outer surface of the handle lever. Moreover, the fastening lever may be adapted to extend into the aperture from the passage so as to be operable from the outer surface of the handle lever.

It will be appreciated, that if a user is prevented from operating the fastening lever, the handle lever cannot be disconnected from the interconnection member. This may be used to prevent theft of the handle assemblies, which in some cases are expensive designer handle assemblies. Accordingly, the aperture may define a threaded inner surface adapted to allow a locking screw to be screwed into the aperture so as to prevent operation of the fastening lever either by preventing access to the fastening lever or by preventing movement of the fastening lever within the aperture. The screw may define a predetermined, non-standard shape requiring a special tool to remove the screw and thereby access the fastening lever.

At least one of the handle levers may be rotatably supported by a rosette adapted to be fixed rotationally relative to the locking device while allowing the handle lever to be rotated relative to the rosette between the locking and non-locking position. Such a rosette may be used to hide an opening made in the door/window for inserting the interconnection member into the manoeuvring member of the locking device form the outer surface of the door/window.

In order to eliminate locking bolts which extend into the door and the locking device, and are used to lock the rosette rotationally relative to the door/locking device, the rosette may comprise one or more resilient member(s) which when the rosette abut the locking device or door/window, causes the rosette to be locked rotationally relative to the locking device/door/window (i.e. the element into which the locking device is mounted), due to the friction between the resilient element and the door/window/locking device. It will be appreciated, that the infinite locking of the handle levers relative to the interconnection member, enables the resilient element of the rosette to be compressed independent of the thickness of the door whereby the friction between the resilient element and the door is increased. Such an increased friction prevents the rosette from rotating relative to the door/window or the like.

In a SECOND aspect the present invention relates to a rosette for rotationally supporting a handle lever, the rosette being adapted to be fixed rotationally relative to a locking device according to any of the preceding claims, while allowing the handle lever to be rotated relative to the rosette, wherein the rosette comprises one or more resilient member(s) which when the rosette abut the locking device or an element into which the locking device is mounted, causes the rosette to be locked rotationally relative to the locking device and/or the element into which the locking device is mounted.

It will be appreciated that the invention according to the second aspect may comprise any combination of features and/or elements of the invention according to the first aspect.

### DESCRIPTION OF THE DRAWINGS

FIG. 1 discloses a first embodiment of the handle assembly,

FIG. 2 discloses a locking device for use in connection with the handle assembly according to the present invention,

FIGS. 3-5 disclose the fastening means of the present invention,

FIG. 6 disclose a isometric view of a handle assembly according to the present invention,

FIG. 7 discloses a rosette according to the present invention,

FIG. 8 discloses a second embodiment of the handle assembly according to the present invention,

FIGS. 9-16 disclose an alternative embodiment of the fastening means, and

FIGS. 17-19 discloses yet another alternative embodiment of the fastening means.

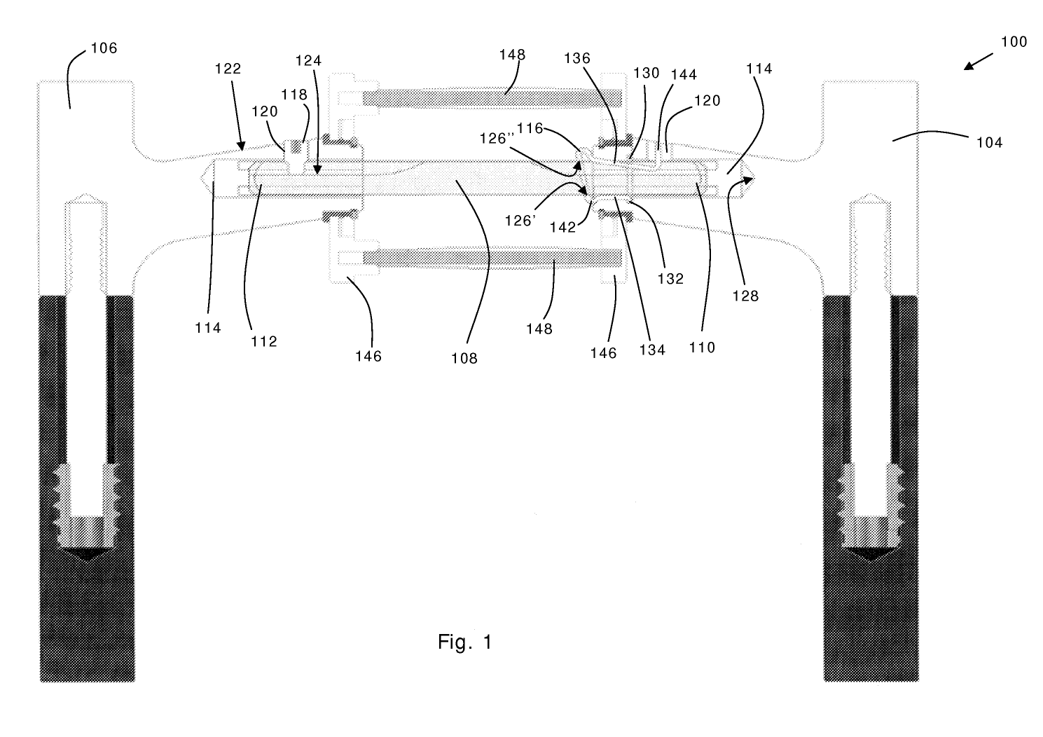

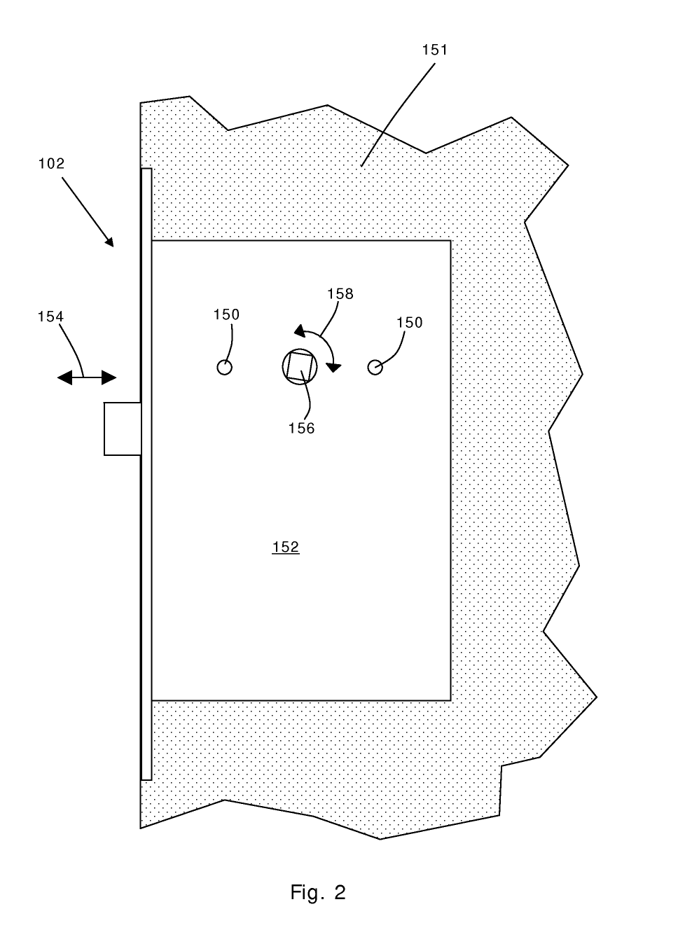

FIG. 1 discloses a first embodiment of a handle assembly 100 for operating a locking device 102, e.g. the one shown in FIG. 2. The handle assembly 100 comprises a first handle lever 104 and a second handle lever 106 which are interconnected by means of the interconnecting member 108. The interconnecting member 108 defines a first end 110 and an opposite second end 112, each of which are adapted to be received in a passage 114 of the first and second handle lever 104,106, so as to allow the interconnecting member 108 to be fastened to the handle levers 104,106.

In FIG. 1 the first handle lever 104 is fastened to the interconnecting member 108 by means of the fastening means 116, while the second handle lever 106 is fastened to the interconnecting member 108 by means of a screw 118. The screw 118 has a threaded outer surface (not visible in the figure) adapted to engage a corresponding threaded inner surface of an aperture 120 of the second handle lever 106. The aperture 120 extends between the passage 114 and the outer surface 122 of the handle lever 106. The second handle lever 106 is fastened to the interconnecting member 108 by screwing the screw 118 into the aperture 120 and into engagement with an engagement surface 124 of the interconnecting member 108, whereby the interconnecting member 108 is locked for movement in both the left and the right direction inside the passage 114, i.e. the interconnecting member 108 cannot be moved out of or further into the passage 114.

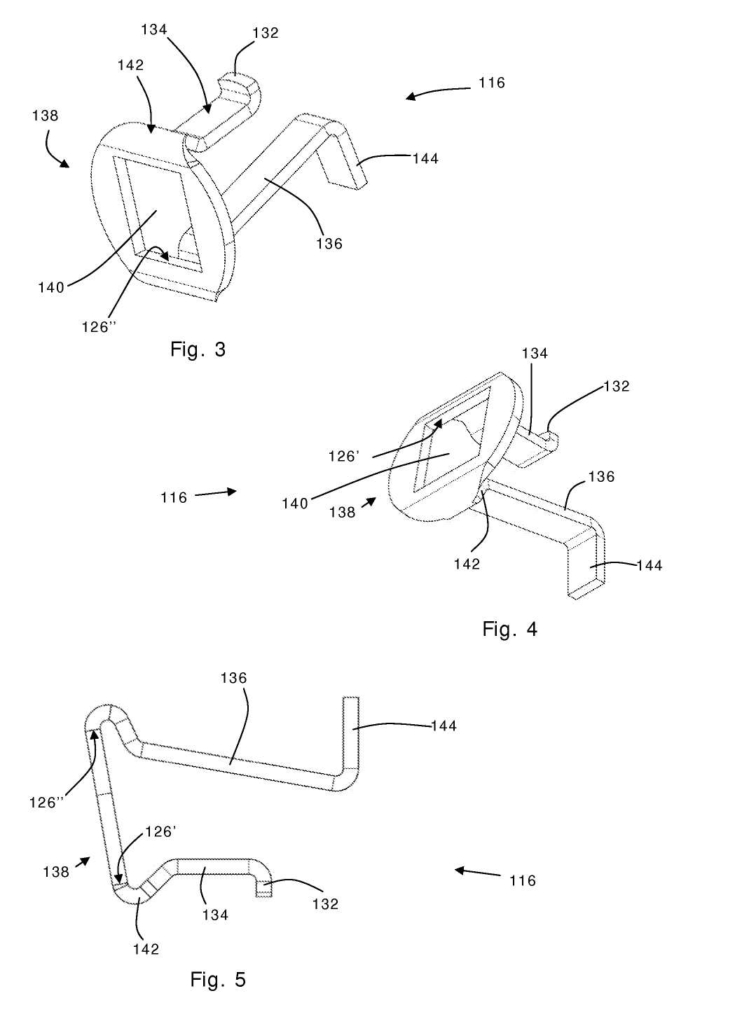

The interconnecting member 108 is fastened to the first handle lever 104 by means of the fastening means 116, which is disclosed in further detail in FIGS. 3-5. The fastening means 116 defines two engagement surfaces 126′,126″, at least one of which is adapted to engage an outer surface of the interconnecting member 108 so as to unidirectionally fasten/lock the interconnecting member 108 to the first handle lever 104. When the interconnecting member 108 is unidirectional locked relative to the first handle lever 104, the interconnecting member 108 is prevented from being moved out of the first handle lever 104 while being free to be moved further into the passage 114 of first handle lever 104. In FIG. 1 this means, that the interconnecting member 108 may be moved in the right direction relative to the first handle lever 104, while being locked for movement in the left direction relative to the first handle lever 104.

It will be appreciated, that abutment between the first end 110 of the interconnecting member 108 and a bottom surface 128 of the passage 114 prevents further movement of the interconnecting member 108 into the first handle lever 104, i.e. to the right in the drawing.

A recess 130 is defined in the passage 114 of the first handle lever 104. The recess 130 is adapted to retain the fastening means 116 in the passage by receiving a protrusion 132 of the fastening means 116. In the embodiment of FIG. 1 the recess 130 extends along the entire inner surface of the passage 114, however it will be appreciated, that in other embodiments the recess 130 is only provided in a part of the inner surface. The protrusion 132 is defined on a retaining lever 134 of the fastening means 116, which in interconnected to a fastening lever 136 via a fastening zone 138, which in the embodiment of FIGS. 3-5 is circular. The fastening zone 138 defines an opening 140 for receiving the interconnecting member 108, when the interconnecting member 108 is inserted into the passage 114 of the first handle lever 104. The opening 140 defines the two engagement surfaces 126′,126″ which are adapted to unidirectionally fasten the interconnecting member 108 to the first handle lever 104 by engagement between the engagement surfaces 126′,126″ and the outer surfaces of the interconnecting member 108.

It will be appreciated, that movement of the interconnecting member 108 into the fastening means 116 i.e. to the right in FIG. 1 and FIG. 5, causes the fastening zone 138 to rotate slightly clockwise relative to the fastening lever 136, due to the flexibility of the bendable zone 142, causing the engagement between the fastening surfaces 126′,126″ and the outer surfaces of the interconnecting member 108 to be less tight.

In the opposite case i.e. wherein the interconnecting member 108 is attempted to be moved out of the first handle lever 104 and thus to the left in FIGS. 1 and 5, the fastening zone 138 is caused to rotate counter clockwise relative to the fastening lever, again due to the flexibility of the bendable zone 142. This causes the engagement between the fastening surfaces 126′,126″ and the interconnecting member 108 to be tightened, whereby the interconnecting member 108 is prevented from being moved out of the first handle lever 104, i.e. in the left direction in FIG. 1.

It will be appreciated, that the abovementioned unidirectionally fastening effect is caused by providing the fastening zone 138 at an angle to the retaining lever 134 which is different for 90 degrees. In one embodiment the angle between the retaining lever and the fastening zone is below 85 degrees, such as below 80 degrees, such as below 75 degrees, such as below 60 degrees. It will be appreciated that the more acute the angle between the fastening zone 138 and the retaining lever 134 (and thus the interconnection member 108) is, the larger the opening 140 of the fastening zone 138 must be in order to allow the engagement surfaces 126′,126″ to be moved into and out of engagement with the outer surface of the interconnection member 108.

In FIG. 1 the fastening means 116 is provided in the fastening position wherein it unidirectionally locks the interconnecting member 108 to the first handle lever 104. In order to allow a user to move the interconnecting member 108 out of the passage 114, the fastening zone 138 must be rotated clockwise relative to the retaining lever 134 so as to bring the engagement surfaces 126′,126″ out of engagement with the outer surfaces of the interconnecting member 108. Said clockwise movement is achieved by moving the fastening lever 136 to the right in the FIGS. 1 and 5, whereby the fastening zone 138 is bended relative to the retaining zone 138 about the bendable zone 142. Provision of a protrusion 144 of the fastening lever 136 which extends into an aperture 120 of the first handle lever 104 allows a user to move the fastening lever 136 to the right.

Moreover it will be appreciated, that if the protrusion 144 and/or the fastening lever 136 are not accessible from an outer surface 122 of the first handle lever 104, the interconnecting member 108 cannot be disconnected from the first handle lever 104. Furthermore, if the first and the second handle levers 104,106 are prevented from being disconnected from the interconnecting member 108, theft of the handle assembly 100 may be prevented in cases wherein the interconnecting member 108 extends through the locking device, as the handle assembly 100 is then locked to the locking device 102. Such theft protection may be achieved either by providing the first and the second handle levers 104,106 with fastening means 116 which is only accessible in special cases, e.g. by means of a special tool. Alternatively, one of the handle levers may be permanently fixed to the interconnecting member 108, while the other handle lever comprises the abovementioned fastening means 116.

A simple way of preventing the fastening lever 136 and/or the protrusion 144 from being moved into the non-fastening position is to provide a screw 118 adapted to be screwed into the aperture 120 so as to make the fastening lever 136 and/or the protrusion 144 inaccessible from an outer surface 122 of the handle lever 104. Advantageously, the screw 118 may be adapted to prevent ordinary tools such as standard screwdrivers or Unbrako spanners (hex keys), from being used to remove the screw 118, by defining a special geometry requiring a spanner defining said special geometry in order to be able to screw the screw 118 into and out of the aperture 120.

It will be appreciated, that the upon delivery of the handle assembly 100 to a user, the screws 118 may be screwed into the apertures 120, as the protrusion 144 and/or the fastening lever 136 need not be accessible from the outer surface 122 of the handle levers 104,106, in order to allow the handle levers 104,106 to be fastened to the interconnecting member 108. Such access to the protrusion 144 and/or the fastening lever is only needed in order to allow the interconnecting member 108 to be moved out of the passage 114 of the handle levers 104,106.

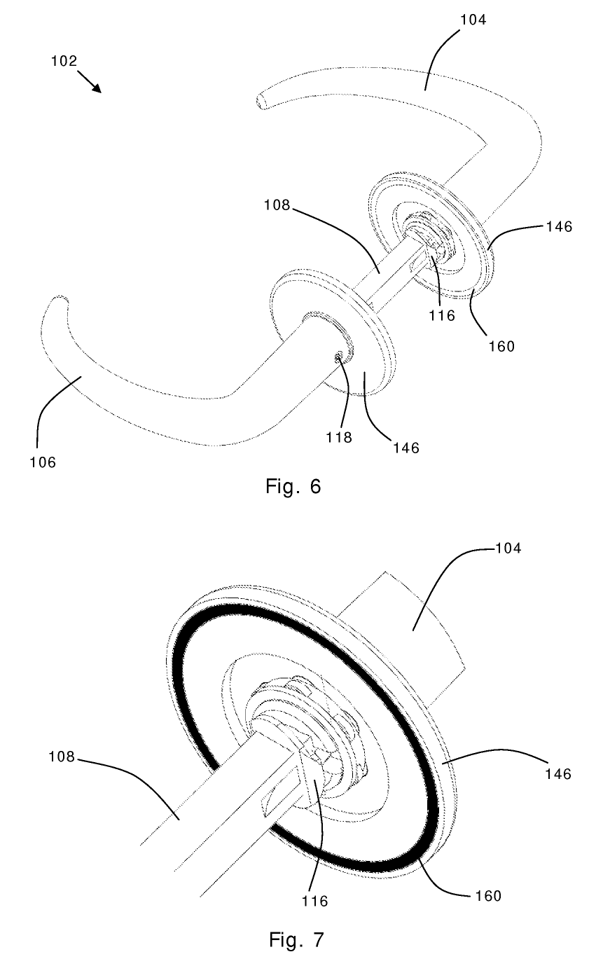

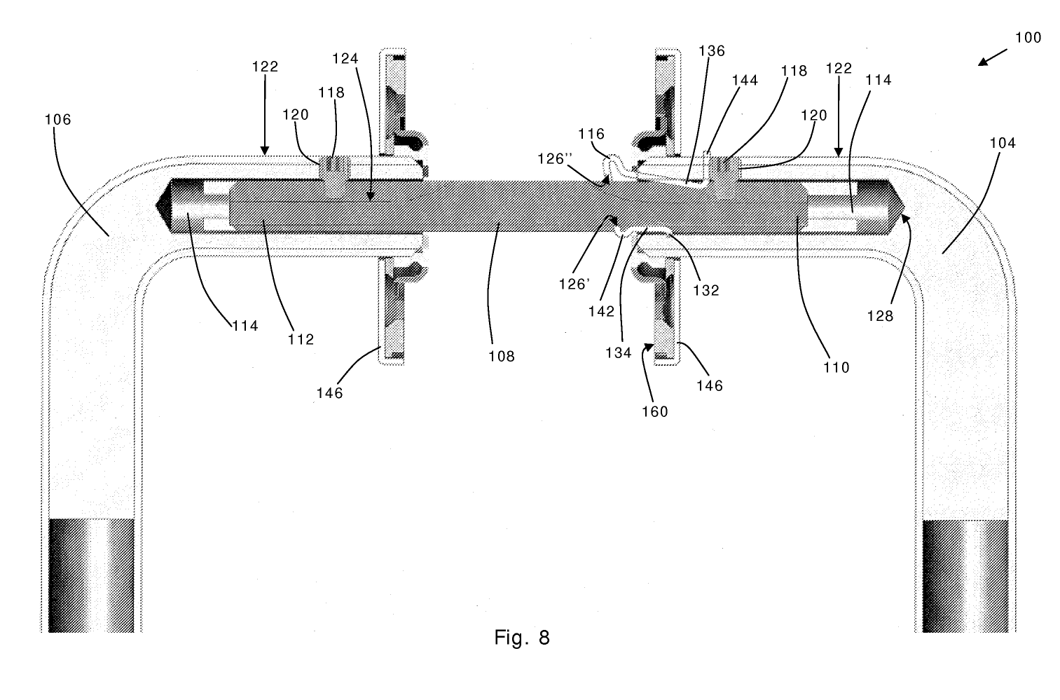

The handle levers 104,106 of FIG. 1 are rotatably supported by rosettes 146 which are adapted to be fixed rotationally relative to a door, window or the like into which the locking device 102 is installed. In order to fix the rosettes 146 rotationally relative to the door, window etc., locking bolts 148 are provided. When the locking device is installed in e.g. a door, the locking bolts 148 are inserted into passages (not shown) of the rosettes 146 and passages 150 of the locking device 102, see FIG. 2, whereby the rosettes 146 are locked rotationally to the locking device 102 and thus the door. In the embodiments of FIGS. 6-8 such bolts may be dispensed with as is described below in relation to said Figs.

FIG. 2 discloses a conventional locking device 102 which may be operated by means of the handle assembly 100 according to the present invention. In FIG. 2 the locking device 102 is installed into a door 151, but it will be appreciated, that the locking device 102 may be installed into any other object which is pivotally or slidably mounted and which is to be secured relative to a frame, casing or the like. Such an another object could be a slidably arranged door, or a picotally mounted window.

The locking device 102 comprises a casing 152 housing the mechanical elements of the locking device. Such mechanical elements comprise the locking member 154 which is adapted to be moved between a locking position as shown in FIG. 2 wherein the locking member 154 extends out of the casing 152 and a non-locking position wherein the locking member 154 is retracted into the casing 152. The non-locking position is not shown in the drawings. The locking device 102 comprises a manoeuvring member 156 for manoeuvring the locking member 154 between the locking and the non-locking position by rotating the manoeuvring member 156 as indicated by arrow 158. The interconnecting member 108 of the handle assembly 100 is adapted to extend through the manoeuvring member 156 so as to allow a user to move the locking member 154 of the locking device 102 between locking and the non-locking position by operation of the hand levers 104,106.

FIG. 6-8 discloses a locking device 102 comprising a first and second handle lever 104,106. The second handle lever 106 is fastened to the interconnecting member 108 by means of the screw 118, and the first handle lever 104 is fastened to the interconnecting member 108 by means of the fastening means 116 as is described in relation to FIG. 1. Identical reference numbers refer to identical elements/objects. However, the handle assembly 100 of FIGS. 6-8 does not comprise the locking bolts 148 for rotationally locking the rosettes 146 to the locking device or a door into which the locking device is installed.

In the embodiment of FIGS. 6-8 the rosettes 146 comprises a circular resilient member 160 adapted to engage a door into which the locking device is installed and onto which the handle assembly 100 is installed so as to allow the locking device to be operated. Due to the friction between the resilient element and the door, the rosettes 146 is rotationally locked relative to the door. Accordingly, the handle levers which are rotationally supported by the rosettes 146 may be rotated without causing the rosettes 146 to be rotated. It will be appreciated, that the more the rosettes 146 are moved into engagement with the outer surface of the door, the better the rotational lock of the rosettes 146 is. Moreover, it will be appreciated that the provision of a handle assembly 100 which allows the handle levers to be locked in an infinite number of position relative to the interconnection member and thereby also the outer surface of the door, allows the rosettes 146 to be moved into the best possible engaging position relative to the door. Accordingly, it may be ensured that the rosettes 146 is rotationally locked relative to the door due to frictional engagement between the resilient member 160 and the outer surface of the door.

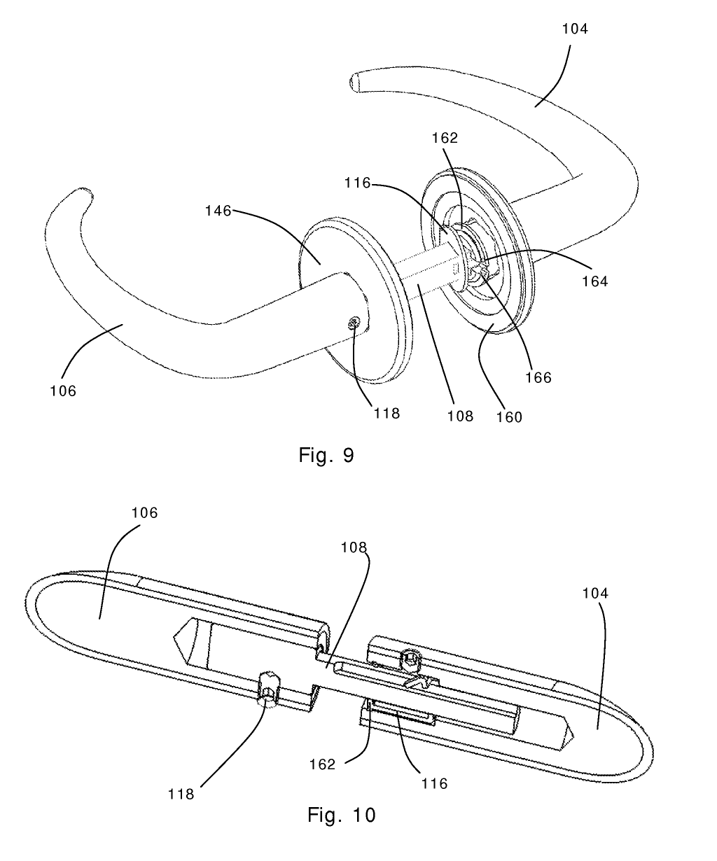

Another difference between FIG. 1 and FIG. 8 is that when the screw 118 in screwed into the aperture 120, the protrusion 144 of fastening lever 136 is accessible from the outer surface 122 of the handle lever 104, but is prevented from being operable as the screw 118 prevents movement of the protrusion 144 with in the aperture 120. Removal of the screw 118 causes the aperture 120 to be unblocked whereby the protrusion 144 may be moved to the right in the drawing such that the fastening means 116 may be moved into the non-fastening position.

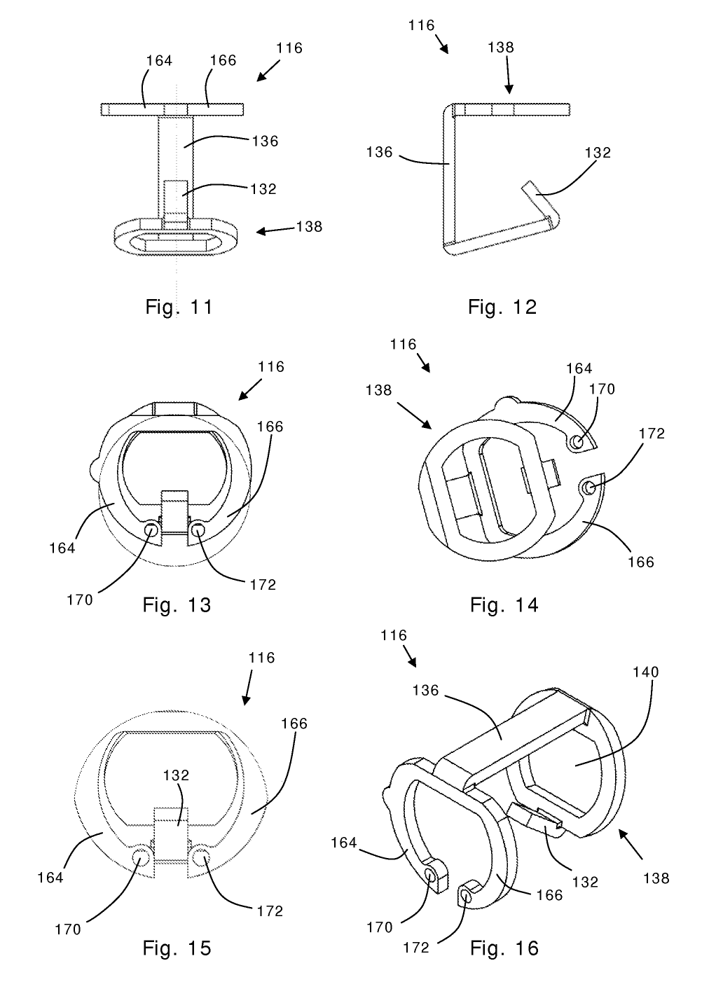

In FIGS. 9-16 the fastening means 116 comprises a locking ring 162 having a first end 164 and a second end 166, which when moved away form each other causes the locking ring 162 to expand. The locking ring is made of resilient material, which causes the first and second ends 164,166 to be biased towards an unbiased position. Locking rings are known in the art, the locking ring 162 of the present invention may be shaped in any known manner. One advantage of the locking ring is that it may be used to fasten/fixate the fastening means 116 to the handle, as illustrated. In the embodiment of FIG. 10 the fastening means 116 is arranged to extend into the handle 104, while being fastened to an outer surface 168 by means of the locking ring 162. In the embodiment of FIG. 10, the fastening means 116 is arranged to extend away from the outer surface 168 of the handle 104. As may be seen in FIGS. 11-16, each of the first and second ends 164,166 defined an indentation 170,172 which is adapted to be engaged by a lock-ring tool and by means of which the ends 164,166 may be moved away form the unbiased position.

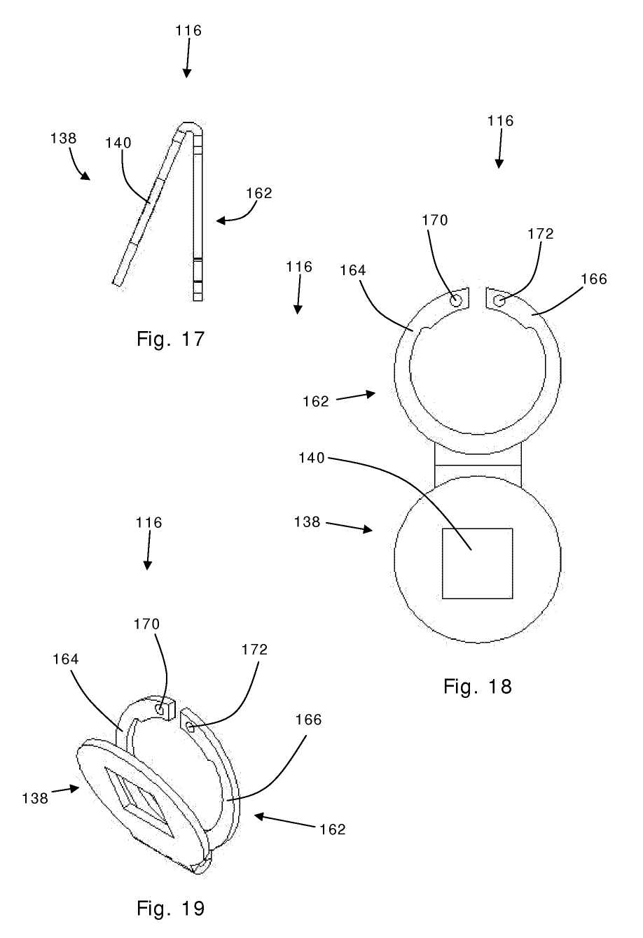

FIGS. 17-19 disclose yet another embodiment of the fastening means 116. Relative to the fastening means 116 of FIGS. 9-16, one difference is that the fastening means of FIGS. 17-19 do not comprise an elongate fastening lever 136. Another difference is that the fastening zone 138 in FIGS. 17-19 extends in a direction away from the locking ring 162, whereas the fastening zone 138 in FIGS. 9-16 extends in a direction towards the locking ring 162.

It will be appreciated that during use, the fastening means 116 is orientated so as to allow the two handle levers to be moved towards each other while preventing the two handle levers from being moved away from each other (without use of tools). Accordingly, the fastening means of FIGS. 17-19 is identical to the one used in FIG. 9, whereas the fastening means of FIGS. 9-16 is identical to the one used in FIG. 10.

1. A handle assembly for operating a locking device having a locking member adapted to be moved between a locking and a non-locking position by manipulation of a manoeuvring member of the locking device, the handle assembly comprising:
a first and a second handle lever;
a rod shaped interconnection member defining two opposite ends each of which is adapted to be received in a passage of the first and/or second handle lever, the interconnecting member being adapted to extend through the locking device such that the interconnection member engages the manoeuvring member, whereby manipulation of one of the handle levers causes the locking member to be moved between the locking and the non-locking position; and
a fastening means for fastening the interconnection member to one of the handle levers when the interconnection member is inserted into the passage of the respective handle lever, and
wherein the fastening means has a fastening position in which the fastening means unidirectionally locks the interconnection member for movement out of the handle lever while allowing further movement of the interconnection member into the handle lever.

2. A handle assembly according to claim 1, wherein the fastening means is adapted to allow the interconnection member to be unidirectionally locked to the handle lever in an infinite number of positions.

3. A handle assembly according to claim 1, wherein the fastening means defines an engagement surface which, when the interconnection member is received in the passage of the handle lever, engages an outer surface of the interconnection member.

4. A handle assembly according to claim 3, wherein the fastening means defines two engagement surfaces which, when the interconnection member is received in the passage of the handle lever, engage two opposite surfaces of the interconnection member.

5. A handle assembly according to claim 1, wherein the fastening means is adapted to be moved between:
an non-fastening position in which the interconnection member is not locked for movement into and out of the passage of the handle lever, and
a fastening position wherein the interconnection member is locked for movement out of the passage of the handle lever.

6. A handle assembly according to claim 4, wherein the fastening means comprises a fastening lever for moving the engagement surface between the fastening and the non-fastening position.

7. A handle assembly according to claim 2, wherein the fastening means defines a opening for receiving the interconnection member, at least a part of the opening defining the engagement surface(s), and wherein the fastening means comprises a resilient zone for biasing the engagement surface(s) into the fastening position.

8. A handle assembly according to claim 6, wherein the fastening lever is operable from an outer surface of the handle lever.

9. A handle assembly according to claim 8, wherein the handle lever defines an aperture extending between the passage and an outer surface of the handle lever, the fastening lever being adapted to extend into the aperture from the passage so as to be operable from the outer surface of the handle lever.

10. A handle assembly according to claim 9, wherein the aperture defines a threaded inner surface and wherein the handle lever comprises a locking screw adapted to be screwed into the aperture so as to prevent operation of the fastening lever.

11. A handle assembly according to claim 1, wherein at least one of the handle levers is rotatably supported by a rosette adapted to be fixed rotationally relative to the locking device while allowing the handle lever to be rotated relative to the rosette between the locking and non-locking position.

12. A handle assembly according to claim 11, wherein the rosette comprises one or more resilient member(s) which when the rosette abut the locking device or an element into which the locking device is mounted, causes the rosette to be locked rotationally relative to the locking device and/or the element into which the locking device is mounted.

13. A rosette for rotationally supporting a handle lever, the rosette being adapted to be fixed rotationally relative to a locking device according to claim 1, while allowing the handle lever to be rotated relative to the rosette, wherein the rosette comprises one or more resilient member(s) which when the rosette abut the locking device or an element into which the locking device is mounted, causes the rosette to be locked rotationally relative to the locking device and/or the element into which the locking device is mounted.
